(19) United States
(12) Patent Application Publication
(10) Pub. No.: US 2005/0159167 A1
(43) Pub. Date: Jul. 21, 2005

(54) Data routing

(75) Inventors: Petteri Hakalin, Oulu (FI); Gerardo Gomez Paredes, Marbella (ES); Hector Montes Linares, Granada (ES)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation, Espoo (FI)

(21) Appl. No.: 10/508,139

(22) PCT Filed: Mar. 25, 2002
(86) PCT No.: PCT/IB02/00919

(51) Int. Cl. H04Q 7/20

(52) U.S. Cl. 455/453; 455/436

(57) ABSTRACT

This invention relates to a method for reducing data congestion in a communication system comprising the steps of identifying a portion of said communication system in which data is congested, selecting one of a plurality of transceiver stations (101, 101′) each having a respective service area in which a mobile station (100) is located, and transferring data between said mobile station (100) and a target node via said selected transceiver station thereby reducing data throughput in said congested portion of the communication system.

The present invention relates to a method and apparatus for reducing data congestion in a communication system. In particular, but not exclusively, the present invention relates to routing data so that data throughput in portions of the communication system which are congested is reduced.

The support of the internet protocol (IP) by wireless user equipment and the convergence of wireless and internet business models together with a general increase in user numbers has lead to an appreciable demand being placed on the communication systems which support them. Various user equipment (UE) such as computers (fixed or portable), mobile telephones, personal data assistants or organisers and so on are known to the skilled person which can be used to communicate with other user equipment in such communication systems or to access the Internet to obtain services. Mobile user equipment is often referred to as a mobile station (MS) and can be defined as a means which is capable of communication via a wireless interface with another device such as a base station of a mobile telecommunication network or any other station. Such a mobile user equipment can be adapted for voice, text message or data communication via the wireless interface.

One problem which can occur in these communication systems is data congestion. That is a congestion of communication traffic. Many reasons are known why congestion can occur in a communication system when a portion of the communication system becomes overloaded. For example because routers (or other network elements) receive data faster than the data can be forwarded from the router.

A number of possibilities have been suggested to overcome the problem of data congestion.

One short term solution which has been suggested is to drop (or discard) packets which are queued at buffers in the communication system to make room for those that are arriving. Alternatively additional packets are prevented from entering the congested portion of the communication system until room for new data has been made.

The skilled person will be aware of the problems inherent with such techniques. Namely that a degradation in the quality of service (QoS) provided by the service occurs.

Another proposed solution to the congestion problem is the use of multiprotocol label switching (MPLS) to route communication traffic along different paths between two points in the communication system. In this way when a network administrator which monitors traffic statistics needs to implement a policy to control congestion the route taken by the data transferred between the two nodes can be controlled.

A problem with such a technique is that between two fixed end points in a communication system there is a limited number of possible routes via which data can be directed.

It is an aim of embodiments of the present invention to at least partly mitigate the above-mentioned problems.

According to a first aspect of the present invention there is provided a method for reducing data congestion in a communication system comprising the steps of: identifying a portion of said communication system in which data is congested; selecting one of a plurality of transceiver stations each having a respective service area in which a mobile station is located; and transferring data between said mobile station and a target node via said selected transceiver station thereby reducing data throughput in said congested portion of the communication system.

According to a second aspect of the present invention there is provided an apparatus arranged to reduce data congestion in a communication system comprising: means for identifying a portion of said communication system in which data is congested; and means for selecting one of a plurality of transceiver stations each of which has a respective service area in which a mobile station is located; whereby data is transferred between said mobile station and a target node via said selected transceiver station to thereby reduce data throughput in the congested portion of the communication system.

According to a third aspect of the present invention there is provided a method of routing data through a communication system comprising the steps of: identifying a portion of the communication system where data is congested; selecting one of a plurality of transceiver stations each having a respective service area in which a mobile station is located; and routing data between said mobile station and a target node via said selected transceiver station whereby data is routed through the communication system away from said congested portion.

According to a fourth aspect of the present invention there is provided a method for controlling congestion of communication traffic in a communication system comprising the steps of: identifying a portion of the communication system where data is congested; modifying the power budget handover margin associated with at least one of a plurality of transceiver stations of the communication system, each having a respective service area in which a mobile station is located; whereby the dominance area associated with said at least one transceiver station is modified in respect to the dominance area of at least one other of said transceiver stations so that a handover (HO) procedure is initiated which routes communication traffic away from said congested portion.

Embodiments of the present invention provide the advantage that, by selecting a new serving transceiver station via which communication from the mobile station to said network is routed, the possibilities for routing data away from congested portions of the system are increased.

Embodiments of the present invention also provide the advantage that they are compatible with existing MPLS algorithms which can thus be utilised in conjunction with the present invention to further reduce data congestion.

Embodiments of the present invention further provide the advantage that user data can be routed from a first to a target end point in the communication system without a need to discard transferred data packets or to stall data flow whilst room is made for new data.

For a better understanding of the present invention reference will now be made, by way of example only to the accompanying drawings in which:

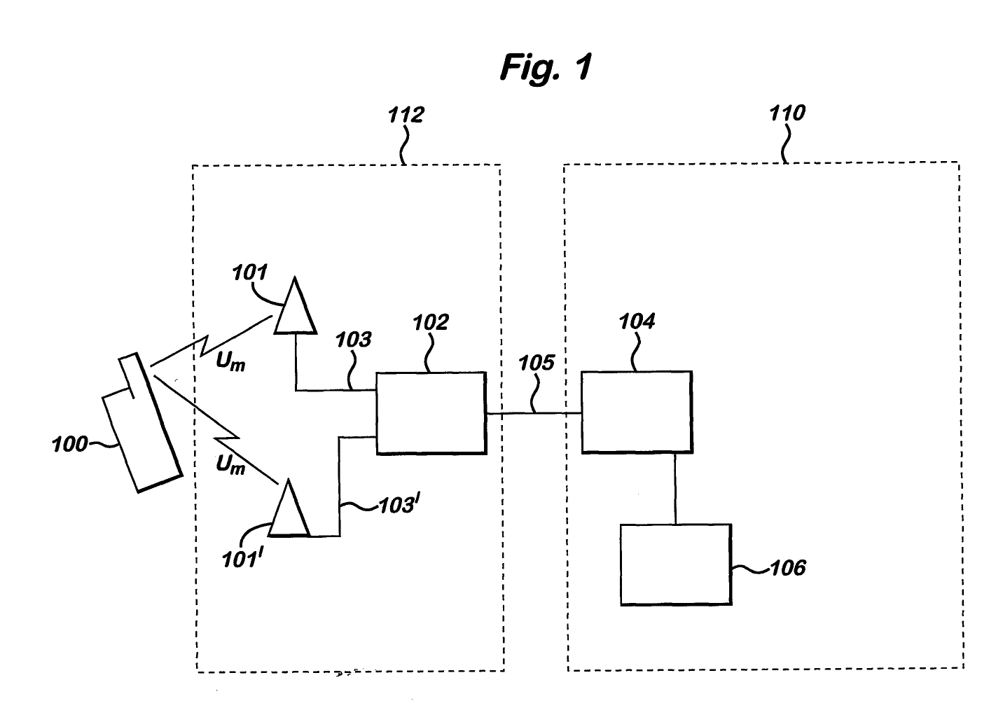

FIG. 1 illustrates parts of a GERAN reference architecture;

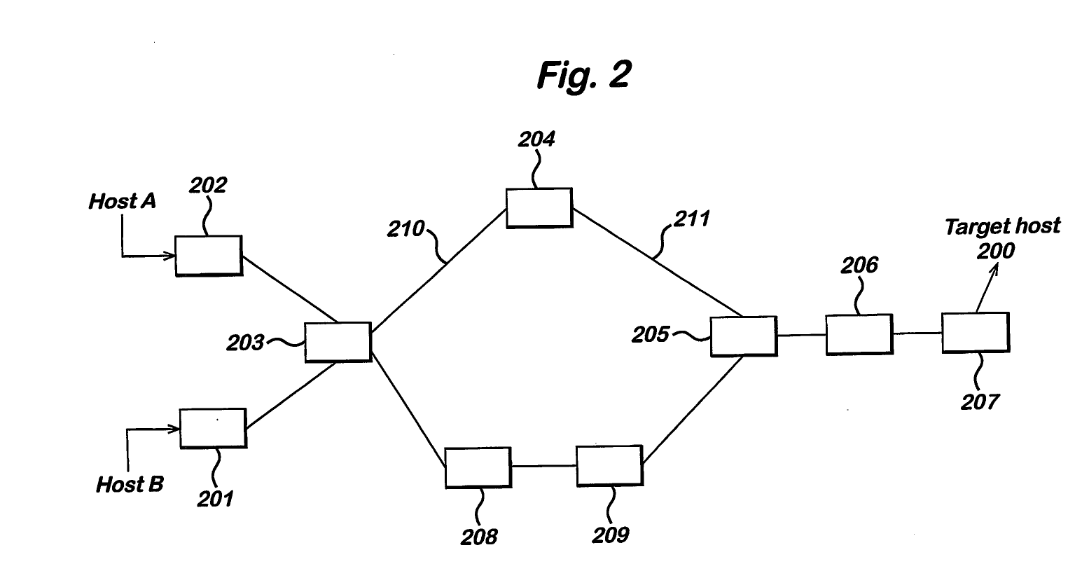

FIG. 2 illustrates a method for overcoming data congestion;

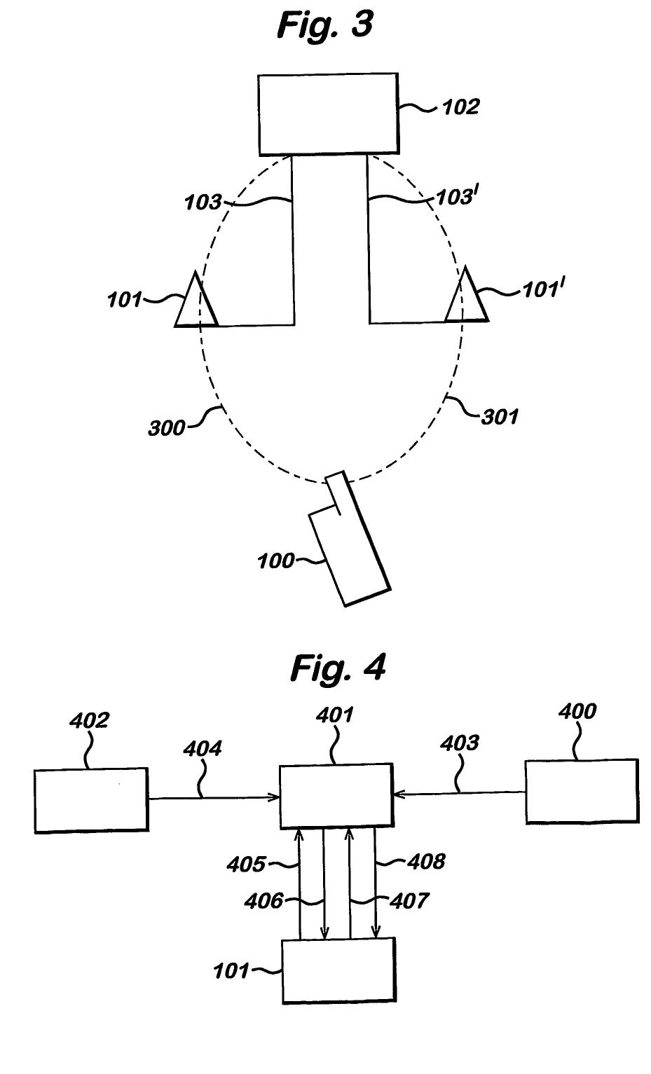

FIG. 3 illustrates a handover procedure; and

FIG. 4 illustrates an interchange of information prior to cell reselection.

In the drawings like reference numerals refer to the parts.

A mobile station (MS) 100 can be a mobile telephone or a laptop computer which has a radio modem or a fax adapted for radio access. The term MS is used here as an example of mobile user equipment (UE). This communicates with one of many (two shown) base transceiver stations (BTS) 101, 101′ over the radio interface (Uₘ Interface). The term BTS is used here also to cover the GSM/EDGE radio access network (GERAN). The BTS is equipment for transmission and reception of signals and may additionally include ciphering equipment. Each BTS in turn communicates with a base station controller (BSC) 102 via link 103, 103′ (A Bis in GSM, Iub in UMTS). The BSC sets up the radio channels for signalling and traffic to the core-network (CN) node 104 via link 105. This forms part of the core-network 110. The other network elements of the core network are not shown for the sake of brevity.

The CN node can be either a mobile switching centre (MSC) or serving GPRS support node (SGSN) depending on the switching domain (circuit switched or packet switched). The CN node 104 is essentially a switching node having many functions. In particular, the CN node performs connection management, mobility management and authentication activities. In this example the CN node also contains the call control function and service switching functions defined by the IN/CAMEL (Intelligent Network/Customised Applications for Mobile network Enhanced Logic) architecture. However, in the package switched domain these before-mentioned CN node functions may be split to separate network elements. Each CN node can control a number of BSC which are referred to as being in an CN node service area. In general BTS's and BSC's together form the radio access network (RAN) 112.

In this way the GERAN can be connected to the third-generation UMTS core network, which supports real-time services and the UMTS QoS architecture. This approach employs a common core network for UTRAN (UMTS (Universal Mobile Telecommunications System) terrestrial radio access network) and GERAN over a common interface.

To connect to the third generation UMTS core network, GERAN uses the Iu interface. This interface can be seen as comprising two parts: the Iu-ps which connects to the packet-switched domain of the core network, and the Iu-cs which connects to the circuit-switched domain.

Data congestion can occur at any point in the communication system. Data congestion will be understood to occur when the flow of data into a node or network element of the communication system exceeds the processing or forwarding power of that node. The congestion may also be caused by a lack of capacity in a link between two network elements or nodes in the system or by other causes as is known to the person skilled in the art.

FIG. 2 illustrates a prior art technique for overcoming data congestion in a communication system. The technique uses a multiprotocol label switching (MPLS) algorithm to route communication traffic around congested portions of a communication system such as a congested network element or congested communication link. As is known in the art MPLS assigns a label field to IP data packets. These labels are used to route the data packets along label switched paths (LSP). LSP's are unidirectional paths between a first and second end of a data path. These are termed the head-end and tail-end. The end to which data is transferred may also be termed the target end or target node. It would be understood that duplex traffic would require two LSP's or data paths one to carry traffic in each direction. The LSP is created by one or more label switched hops which allow a packet to be forwarded from one label switching router (LSR) to another LSR across the MPLS network. It would be understood that an LSR is an network element which routes data packets from one node to another in the communication system which supports MPLS based forwarding.

FIG. 2 illustrates how MPLS supports applications which require more than just destination based forwarding. If either host A or host B were to transmit data in the form of data packets to the target host 200 the packets would flow via the shortest route across the communication system. This would be via either router 201 or 202 through router 203, router 204 to router 205 and on to the target host 200 via further routers 206 and 207. In the situation where a network administrator which monitors communication traffic identifies congestion in the communication system and thus needs to implement a policy to control congestion at for example router 204 MPLS allows the data path to be changed. According to an MPLS algorithm congestion would be reduced at router 204 by either avoiding or redistributing traffic load along that data path. Traffic originating at host A and destined for the target host 200 would be allocated to a first LSP1 whilst traffic sourced at host B and destined for target host 200 would follow a second data path LSP2. This would be implemented by the network administrator allocating the two data paths. Thereafter LSR 203 would be configured to put all traffic received from host A and destined for the target host 200 into LSP1 and all traffic received from host B destined for target 200 into LSP2. In this way data from router 203 can follow the path to router 205 via router 204 or via routers 208 and 209. It would be understood that if severe congestion were to occur at a network portion in data path 1 (which includes the link 210 between router 203, router 204 and the link 211 between router 204 and router 205) then either all, most or some of the data could be routed via routers 208 and 209. It will also be understood that whilst this provides one manner in which congestion can be reduced in the communication system the ability to route data around congested areas (or portions) of the system is limited. For example the above-mentioned technique provides little opportunity for routing around congestion at routers 203 or 205. Likewise only two possible data paths between nodes 203 and 205 are provided.

FIG. 3 illustrates a manner in which data congestion can be reduced in a communication system in accordance with an embodiment of the present invention. FIG. 3 illustrates the radio access network and shows two transceiver stations 101 and 101′ which are connected to a base station controller 102 which acts as a RAN gateway (RNGW). The base transceiver stations 101, 101′ will be understood be analogous to a base station gateway (BSGW). When data congestion is identified by a network administrator 106 either at the transceiver stations 101 or at its link 103 to base station controller 102 or at base transceiver station 101′ or its link 103′ to base station controller 102. The congested area can be avoided by carrying out a handover procedure so that data is transferred from the mobile station to the target node via the new transceiver station. In this way data throughput in a congested area can be avoided.

The concept of handover will be well understood to a person skilled in the art. Each transceiver station 101, 101′ is associated with a service area (or cell) which is a geographical area proximate to the transceiver station. It will be understood that the term service area covers also the case when more than one cell is associated with a particular transceiver station. In such a circumstance the service area covers the area of all cells associated with that transceiver station. When a mobile station is located within this service area the mobile station can communicate with the transceiver station over the Uₘ interface. Handover can take place for a number of reasons. Either because the mobile station moves geographically so that it no longer is located within a service area of a particular transceiver station or when the radio resource, that it the capacity over the radio interface Um of a particular transceiver station is overloaded or itself congested. The mobile station 100 maybe located at any one time within the service area of a plurality of transceiver stations. Two are shown in FIG. 3. A dominance area is associated with each service area of the transceiver stations. The service area defines the maximum area within which a mobile station maybe served by the transceiver stations. The dominance area maybe adjusted so that a mobile station located proximate to a transceiver station is more or less likely to communicate with the core network via that particular transceiver station.

By way of example path 300 shown by the dashed line represents the path data transferred through the communication system would take when the mobile station communicates via transceiver station 101. Path 301 illustrated by the chained line illustrates the path which data would be transferred along should a handover occur from transceiver station 101 to 101′.

FIG. 4 illustrates how handover can be controlled in the communication system according to embodiments of the present invention. It will be understood that the present invention is not limited to the control of handover between transceiver stations in accordance with this specific description. The quality of service (QoS) in the transport network domain of the communication system is managed by an entity called the IP Transport Resource Manager (ITRM) 400. The ITRM monitors the flow of IP data through the network and receives measurements from the various network elements indicating amongst other things traffic congestion. The ITRM 400 also stores information relating to the IP network topology for the routing domain that it manages. In this way if congestion is identified the ITRM will contain information necessary to enable a further transceiver station to be selected. The ITRM detects a location of congestion in the transfer network and using this information identifies IP-BTS 101, 101′ which may be affected by the congestion. In alternative embodiments the ITRM may also hold information relating to the traffic classes which are affected by the congestion (ie. Whether conversational, interactive, streaming or background classes of data are affected). According to this embodiment of the present invention the ITRM reports IP transport load information from the base station gateway (associated to an IP (BTS)) to the core network. In alternative embodiments the transport load information between the base station gateway and the radio access network gateway could be reported. It will be understood that when there are multiple RNGW connected to the same BSGW embodiments of the present invention provide that the ITRM determines the cost functions corresponding to each possible route and reports these to the common resource management server (CRMS) 401. It will be understood that the term “cost function” broadly represents the IP transport load percentage (for example 0-100% or a similar representation) from a base station gateway (associated with an IP-BTS) to a RNGW. In other words it represents the transmission load level for each pair of IP addresses (BSGW-RNGW). The common resource management server (CRMS) provides RAN wide resource management and provides basic policy management functions for access to the cells and radio bearer resources within RAN. In this way the CRMS 401 is provided with the information indicating congestion in the communication system and will be able to determine which of the possible data paths should be selected for transmission of data.

The CRMS 401 also receives signals from an operations and management server (OMS) 402. This server includes functions for monitoring performance, configuration management and fault management for the RAN network. In particular parameters utilised during cell reselection operations when handover occurs are transmitted from the OMS 402 to the CRMS 401. This information can be used to identify cells served by an associated transceiver station which have a low path loss from the radio propagation point of view. These perimeters can be used by the CRMS unit in addition to further information obtained in the communication system to enable a decision to be made as to which route data should be transferred along in the communication system.

The CRMS is also provided, via a third input signal 405 with information indicating the transport load on the base station gateway. This is provided from BTS 101. In response to the information from the OMS 402, ITRM 400 and BTS 101 the CRMS, in accordance with embodiments of the present invention recalculates power budget handover margins for the BTS 101. These are transmitted via signal 406. By controlling the handover margins the dominance area of congested cells can be reduced with respect to the dominance areas of non-congested cells. In this way some connections can be indirectly forced to move (or handover) towards adjacent cells away from congested cells. The BTS 101 responds with a prioritise list required message 407 which is processed in the CRMS 401 which returns a prioritised list response 408. In this way when the IP BTS determines that a handover operation should be started (taking into account the new power budget HO margins), then it can ask for the prioritisation of the possible candidate cell list (to perform a HO) to the CRMS by sending a ‘Prioritised List Request’ message. Afterwards, the CRMS returns the reordered candidate cell list to the source IP BTS in a ‘Prioritised List Response’ message. On the basis of these signals and messages cell reselection can take place so that data is subsequently routed via a less congested portion of the communication system.

In embodiments of the present invention the ITRM 400 estimates a load percentage (or cost function) for each pair of IP addresses (or the possible data paths) the IP addresses identify the end points from host to target along which data should be transferred in the communication systems. In this way a quanitive estimate of the load or volume of communication traffic on each possible data path can be determined. It will be understood that the congestion can be located at any network element or link in the communication system.

According to further embodiments of the present invention each transceiver station may be associated with more than one service area or cell. In such a case subsequent to the identification of a portion of the communication system in which data is congested the call can be handed over from a first to a selected service area. In this way intra-cell hand over can be used to reduce congestion in a communication system. Alternative embodiments reduce data throughput in a congested portion of the communication system by switching to either different time slots on a communication link or by selecting a new RF carrier frequency for the communication link.

According to embodiments of the present invention in order to avoid superfluous information flooding from the ITRM to the CRMS a threshold level maybe predetermined so that if a cost function is below this threshold there is no need for the information to be provided to the CRMS from the ITRM via message 403. In this way either a decision can be made whereby congestion in the communication data path is sufficiently low as to be acceptable and therefore no handover need be required. As an alternative possible routes which have a level of load or other characteristic, indicating congestion above a predetermined maximum threshold will not be reported to the CRMS as possible handover targets. In addition transport load information for each pair of IP addresses for each type of traffic class or for each DiffServ class may also be reported to the CRMS. It will be understood that the different UMTS traffic classes (conversational, streaming, interactive and background) are mapped onto DiffServ classes in the IP transport domain (DiffServ CodePoints (DSCPs) in the IP header). Expedited Forwarding (EF) classes only represent those services which need low loss, low latency and assured bandwidth within the DiffServ architecture.

The information provided to the CRMS can be provided continually or maybe provided periodically in order to enable the power budget handover margins to be modified accordingly. It will be understood that the CRMS should be provided with information identifying which end points of a data path are affected with congestion. A possibility for this to be enabled is that the CRMS should be provided with a facility to translate the cell id's from the IP address and port number information provided with each data packet. According to embodiments of the present invention the handover margins can be tuned automatically so that the communication system is auto tuned to provide routing so as to achieve minimum congestion in the system. The auto tuning procedure can be performed separately for the IU-ps and IU-cs interfaces. It will be understood that the IU-ps interface connects the packet switched domain of the core network to the GERAN whereas the IU-cs interface connects GERAN to the circuit switch domain in the core network.

According to alternative embodiments the present invention can also be used in an idle mode in which parameters are auto tuned within GERAN thus enabling the performing of primitive actions against transport layer congestion already in an idle mode. As an example cell reselect offset parameters of the cells (or pairs of cells) could be tuned according to transport congestion information by controlling or setting the parameters for each cell. It is thereby possible to ensure that optimum tuning is constantly carried out so that when transfer of data is required data is routed via a route having an acceptable level of congestion or away from congested areas.

In further embodiments of the present invention the ITRM 400 can detect when an IP network element (ie. an IP router or IP gateway) suffers from IP data congestion. When data throughput in such a congested area is identified as being indicative of congestion the ITRM can trigger a handover by signalling this to the handover control unit in a IP-BTS. Subsequently the CRMS can order the list of possible transceiver stations serving the location where the mobile station is located taking into account a characteristic of the communication system. This maybe either the radio status of the cells (for example what is the volume or load or conditions of the radio link from the mobile station to each IP-BTS) or IP transport load information (which is indicative of the volume of data traffic). It will be understood that embodiments of the present invention may use combinations of the methods for reducing congestion mentioned above.

Embodiments of the present invention provide an improved power budget handover margins auto tuning algorithm which takes into account transmission load in the IP network in order to make cells associated with particular transceiver stations less attractive or even to avoid communication traffic being routed through the cells. This achieved by selecting a transceiver station associated with a data path having low data congestion or a data path which directs data away from congested areas. Thereafter a handover of a communication link from the mobile station to a target node in the communication system is carried out.

An IP transport resource management unit in the core network monitors and reports IP transport load information. Alternatively an error rate at a target node in the communication system can be monitored. When a congested data path is identified the IP end point of the congested IP route is proposed to be changed by using a IP-BTS relocation instead of making changes in the IP routing to the current serving IP-BTS. In addition to improving congestion by carrying out a handover from a current serving IP-BTS to a new selected BTS data can be routed from the new selected BTS to the target node using an MPLS routing algorithm.

It will be understood that the present invention is not limited to having the functionality required placed in specific separate nodes. Rather it will be understood that the functionality can be distributed at any suitable node.

It is also noted that whilst the above describes preferred embodiments of the invention, variations and modifications may be made without departing from the scope of the present invention.

1-21. (canceled)

22. A method for reducing data congestion in a communication system comprising the steps of:
identifying a portion said communication system in which data is congested;
modifying the power budget handover margin for at least one of a plurality of transceiver stations each having a respective service area in which a mobile station is located;
selecting one of said plurality of transceiver stations; and
transferring data between said mobile station and a target node via said selected transceiver station thereby reducing data throughput in said congested portion of the communication system.

23. The method as claimed in claim 22 further comprising:
transferring data between said mobile station and said target node via a first transceiver station;
executing a handover procedure from a first to said selected transceiver station; and
subsequently transferring data between said mobile station and said target node via said selected transceiver station.

24. The method as claimed in claim 22 further comprising the steps of:
transferring data between said mobile station and said target node via a first data path having a first and second end point;
selecting a new end point; and
subsequently routing data via a second data path having first and second end points corresponding to said first and said new end points respectively.

25. The method as claimed in claim 22 wherein said step of selecting one of said transceiver stations comprises:
for each one of said plurality of transceiver stations having a service area in which said mobile station is located, determining a characteristic of the data throughput along a respective data path from the mobile station to the target node via that transceiver station;
comparing the determined characteristic for each data path; and
selecting the transceiver station in response to said comparison.

26. The method as claimed in claim 25 further comprising selecting the transceiver station associated with the data path which is identified as being least congested.

27. The method as claimed in claim 25 wherein said step of modifying the power budget handover margin for at least one transceiver station varies the dominance area of the service area associated with each of said plurality of transceiver stations and is in response to the determined characteristic for each respective data path.

28. The method as claimed in claim 27 wherein the dominance area of a transceiver station associated with a data path having a low level of congestion relative to a level of congestion in a further data path associated with another of said transceiver stations, is increased relative to that of said another transceiver station.

29. The method as claimed in claim 22 wherein said step of selecting one of said transceiver stations comprises:
identifying a router node in said communication system in which data throughput is congested; and
selecting one of said plurality of transceiver stations so that data is transferred via said selected transceiver and is not transferred from the mobile station to the target node via said identified router.

30. The method as claimed in claim 22 8 further comprising the steps of:
identifying if data throughput is congested by determining when a characteristic of the data throughput in the communication system indicates that data throughout is congested.

31. The method as claimed in claim 30 wherein said characteristic comprises load information indicating the volume of data throughput in at least a portion of the communication system.

32. The method as claimed in claim 30 wherein said characteristic comprises an error rate of data indicating the quality of a data path between said mobile station and the target node.

33. The method as claimed in claim 22 wherein said data comprises IP data packets.

34. The method as claimed in claim 22 further comprising the steps of forwarding data between said selected transceiver station and said target node based on a multiprotocol label-swapping forwarding algorithm.

35. The method as claimed in claim 22 further comprising the steps of:
monitoring transport congestion during an idle mode of operation prior to said transfer of data;
responsive to said monitoring, selecting at least one transceiver station during said idle mode of operation; and
upon initiation of data transfer, transferring data via said at least one transceiver station selected during idle mode of operation.

36. Apparatus arranged to reduce data congestion in a communication system comprising:
means for identifying a portion the location of said communication system in which data is congested; means for modifying the power budget handover margin for at least one of a plurality of transceiver stations each of which has a respective service area in which a mobile station is located; and
means for selecting one of a plurality of transceiver stations; whereby
data is transferred between said mobile station and a target node via said selected transceiver station to thereby reduce data throughput in the congested portion of the communication system.

37. Apparatus as claimed in claim 36 further comprising:
means for executing a handover procedure from a first to said to said selected transceiver station.

38. A method of routing data through a communication system comprising the steps of:
identifying a portion the location of said communication system where data is congested;
modifying the power budget handover margin for at least one of a plurality of transceiver stations each having a respective service area in which a mobile station is located;
selecting one of said plurality of transceiver stations; and
routing data between said mobile station and a target node via said selected transceiver station whereby data is routed through the communication system away from said congested portion.

39. A method for controlling congestion of communication traffic in a communication system comprising the steps of:
identifying a portion of the communication system where data is congested;
modifying the power budget handover margin associated with at least one of a plurality of transceiver stations of the communication system, each having a respective service area in which a mobile station is located; whereby
the dominance area associated with said at least one transceiver station is modified in respect to the dominance area of at least one other of said transceiver stations so that a handover procedure is initiated which routes communication traffic away from said congested portion.

40. A method for reducing data congestion in a communication system comprising the steps of:
identifying a portion the location of said communication system in which data is congested;
modifying the power budget handover margin for at least one of a plurality of transceiver stations;
transferring data between a mobile station and a target node via a first RF carrier of a communication link;
executing a handover procedure from said first to a second RF carrier of said communication link; and
subsequently transferring data between said mobile station and said target node via said second RF carrier thereby reducing data throughput in said congested portion of the communication system.

41. A method for reducing data congestion in a communication system comprising the steps of:
identifying a portion the location of said communication system in which data is congested;
modifying the power budget handover margin for at least one of a plurality of transceiver stations;
selecting one of a plurality of service areas, associated with a respective transceiver station, in which a mobile station is located; and
transferring data between said mobile station and a target node via said selected service area thereby reducing data throughput in said congested portion of the communication system.

42. The method as claimed in claim 41 further comprising:
transferring data between said mobile station and said target node via a first of said plurality of service areas;
executing a handover procedure from said first to said selected service area; and
subsequently transferring data between said mobile station and said target node via said selected service area.
